(19) United States
(12) Patent Application Publication
(10) Pub. No.: US 2016/0019629 A1
(43) Pub. Date: Jan. 21, 2016

(54) CONTEXT RICH CONSENT CONTROLLED FOOD PURCHASE MANAGEMENT

(71) Applicant: Kitchology Inc., Wilmington, DE (US)

(72) Inventors: Alain C. Briancon, Poolesville, MD (US); Michele A. Drgon, Stuart, FL (US); Iris S. Sherman, Kennebunk, ME (US); Walter B. Wynes, Abingdon, MD (US); Alicia V. Briancon, Silver Spring, MD (US); Alyson S. Durham, Kennebunk, ME (US); Ian T. Durham, Kennebunk, ME (US)

(73) Assignee: Kitchology Inc., Wilmington, DE (US)

(21) Appl. No.: 14/790,623

(22) Filed: Jul. 2, 2015

Related U.S. Application Data
(63) Continuation of application No. 13/730,210, filed on Dec. 28, 2012.
(60) Provisional application No. 61/581,925, filed on Dec. 30, 2011.

(51) Int. Cl. G06Q 30/06; G06Q 20/32; H04L 29/06

(52) U.S. Cl. CPC G06Q 30/0633; H04L 63/0853; G06Q 20/327

(57) ABSTRACT

A method, apparatus and system for generating contextual information associated with a commercial transaction are described. A unique transaction identifier: is received from a scanned code, identifies a specific commercial transaction between a consumer and a retailer and serves as an authorization, by the consumer, to transfer information relating to the specific commercial transaction to a database associated with an account of the consumer. If the unique transaction identifier is received, a list of goods purchased by the consumer during the transaction is retrieved from a computer associated with the retailer and additional information to retrieve is determined based on at least one preference of the consumer. The additional information is retrieved and stored in the database associated with the account of the consumer for use in providing at least one of food budgeting services, diet monitoring services or economic offers to the consumer through an application.

### CROSS REFERENCE TO RELATED APPLICATION

This application is a continuation of U.S. patent application Ser. No. 13/730,210, filed Dec. 28, 2012, which claims the benefit of U.S. Provisional Application No. 61/581,925, filed Dec. 30, 2011, which are incorporated herein by reference as if fully set forth.

### FIELD

The present disclosure relates to providing assistance to consumers, retailers and producers in sharing information about food purchases without loss of privacy.

### BACKGROUND

Collecting information about purchases for the purpose of helping consumers with food budgeting, diet monitoring or to provide economic offers is not novel. However, the methods used were developed before the age of ubiquitous cell phone adoption, the emergence of smart phones and the focus of society about privacy and use of data collected during electronics transactions.

Transfer of purchase information from online providers is relatively straight forward, but while a lot of transactions are taking place online, shopping at brick and mortar store still accounts for the majority of purchases, especially food.

It is important to ease data collection so that consumers do not have to key in tedious information. The challenge is to allow consumers to give consent to data input about their purchases in an easy manner.

In U.S. Pat. No. 7,870,019, Williams et al. teaches providing to a consumer a series of offers on multiple devices such as: kiosks, point of sale terminals or electronic transaction systems, and working out which offer is effective to reach a specific consumer. In U.S. Pat. No. 7,958,224, Amjadi teaches transmitting to a client device (cellphone) an incentive (in the form of a coupon). The context of that transaction requires knowledge of whether this specific consumer subscribes to an offer network. It suffers from the major set back of not allowing transaction-by-transaction buy in for offers, and fails to tailor offers to specific consumer circumstances.

In U.S. Pat. No. 8,014,726, Petersen and Stapleton teach a method to monitor actions from users (such as purchases) that is undetectable by the user. In these days where privacy is important and malware is prevalent, this solution is not accessible to many consumers who want to control how information about their food purchases or consumption is captured and used.

In U.S. Pat. No. 8,024,220, Ariff et al. teaches a loyalty program where the retailer integrates purchase information from the consumer and his or her demographic information and previous purchases, but does not provide means for the consumer to control this information gathering nor use. This is hardly acceptable if privacy is a concern. Cohagan et al. teach of a similar concept where the rewards are based on geography. This suffers from the same shortcomings.

### SUMMARY

In an aspect, the invention relates to a computer-implemented method for recording a transaction for goods or services, and their associated context, between one or more suppliers, and one or more consumers. The method includes accessing a list of goods or services using a submission system, and accessing one or more property attributes associated with one or more goods or services of said list of goods or services. The one or more property attributes are selected from the group consisting of: a chemical property; a physical property; a nutritional property; an economic property; a mechanical property; a geographic property; a manufacturing property; and a temporal property. The method includes accessing at least one attributable submission indicator from the group consisting of: location, time, and consumer ID; generating one or more submission data records from said one or more property attributes, and said at least one attributable submission indicator within a submission system; generating one or more meta-elements associated with said one or more submission data records; generating one or more representations of said one or more meta-elements; extracting said one or more meta-elements from a physical, logical or digital representation with an extracting device; accessing one or more extraction attributes from the group consisting of: location, speed, time, velocity, orientation, sound, lighting, extracting device parameters; and application parameters; and generating at least one unique transaction identifier based on said one or more meta-elements and said one or more extraction attributes.

In an aspect, the invention relates to a transaction processing system. The transaction processing system includes an Ad-hoc Pair of Computers (APC). The APC includes a first computer capable of performing a first method and a second computer capable of performing a second method. The first method includes accessing a transactional collection of records of goods or services, accessing one or more property attributes associated with one or more goods or services of said transactional collection, wherein the property attribute is selected from the group consisting of: a chemical property, a physical property, a nutritional property, an economic property, a mechanical property, a geographic property, a manufacturing property, and a temporal property, accessing at least one attributable submission indicator from the group consisting of: location, time, and consumer ID, generating one or more submission data records from said one or more property attributes and said at least one attributable submission indicator, generating a meta-element associated with said submission data records, and generating one or more representations of said meta-element. The second method includes extracting the one or more representations of said meta-element with an extracting device, accessing one or more extraction attributes from the group consisting of: location, time, and space, extracting the one or more extraction attributes, and transmitting said one or more extraction attributes to the first computer. The first computer or the second computer is capable of performing the method: generating a unique transaction identifier based on said meta-element and said one or more extraction attributes, and transmitting said unique transaction identifier to the other computer of the APC.

### BRIEF DESCRIPTION OF THE DRAWINGS

The following detailed description of the preferred embodiments of the present invention will be better understood when read in conjunction with the appended drawings. For the purpose of illustrating the invention, they are shown in the drawings embodiments, which are presently preferred. It is understood, however, that the invention is not limited to the precise arrangements and instrumentalities shown. In the drawings:

FIG. 1 illustrates the recording of context information at or around a transaction.

FIG. 2 illustrates the creation of metadata for a transaction.

FIG. 3 illustrates the creation of context information by an extractor.

FIG. 4 illustrates the interaction with a consumer kitchen diary.

### DETAILED DESCRIPTION OF THE PREFERRED EMBODIMENTS

Certain terminology is used in the following description for convenience only and is not limiting. The words “right,” “left,” “top,” and “bottom” designate directions in the drawings to which reference is made.

As used herein, “connected” means that elements within the system are connected physically or through a remote connection such that they are functionally connected. This connection can be temporary or permanent. As a non-limiting example, a remote connection may be through a localized Radio Frequency link.

The claims and corresponding specifications refer to “first computer”, “second computer”, “third computer” and “fourth computer”. It is understood that these computers might be but are not limited to portable devices, personal computers, servers, cloud computing based platforms and implementations. It is understood that these computers might be merged.

The words “extractor”, “extraction device” and “extracting device” are used interchangeably.

All numbers expressing quantities of ingredients, goods, properties, and other parameters used in the specification and claims may be modified in all instances by the term “about.” Unless indicated to the contrary, the numerical parameters set forth in the following specification and attached claims are approximations that may vary depending upon the desired properties to be obtained. At the very least, and not as an attempt to limit the application of the doctrine of equivalents to the scope of the claims, each numerical parameter should at least be construed in light of the number of reported significant digits and by applying ordinary rounding techniques.

All numerical ranges herein include all numerical values and ranges of all numerical values within the recited numerical ranges. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The words “a” and “one,” as used in the claims and in the corresponding portions of the specification, are defined as including one or more of the referenced item unless specifically stated otherwise. This terminology includes the words above specifically mentioned, derivatives thereof, and words of similar import. The phrase “at least one” followed by a list of two or more items, such as “A, B, or C,” means any individual one of A, B or C as well as any combination thereof.

Embodiments include computer-implemented methods for recording a transaction for goods or services, and their associated context, between one or more suppliers, and one or more consumers. The computer-implemented methods may include accessing a list of goods or services using a submission system, accessing one or more property attributes associated with one or more goods or services of said list of goods or services, accessing at least one attributable submission indicator, generating one or more submission data records from said one or more property attributes and said at least one attributable submission indicator within a submission system, generating one or more meta-elements associated with said one or more submission data records, generating one or more representations of said one or more meta-elements, extracting said one or more meta-elements from a physical, logical or digital representation with an extracting device, accessing one or more extraction attributes, and generating at least one unique transaction identifier based on said one or more meta-elements and said one or more extraction attributes.

The one or more property attributes may include a chemical property, a physical property, a nutritional property, an economic property, a mechanical property, a geographic property, a manufacturing property, and a temporal property.

The at least one attributable submission indicator may include location, time and consumer ID.

The one or more extraction attributes may include location, speed, time, velocity, orientation, sound, lighting, extracting device parameters, and application parameters.

Representation of the one or more meta-elements may be physical, digital or logical. Representation of the one ore more meta-elements may include a graphic icon, a numeric sequence, an alphanumeric sequence, a display, a barcode, a QR code, a watermark, a tattoo, an RFID, an NFC tag, a captured image, chemical and nano-particulate taggants, a mechanical deformation, a mechanical alternation, a button on a touch-screen, or an element of interface.

The submission system may include a personal computer, a computer, a point of sell system, a portable point of sale system, a cellphone, a tablet, a cash register, a server, a cloud based system, an electronic transaction device, a transaction log processing system, a restaurant management system, a kitchen management system, a webpage presented on browser, or an inventory management system.

The extracting device may include a personal computer, a wireless transmit/receive unit, a cellphone, a tablet, an FOB, a scanner, a near-field communication reader, an infrared reader, an LED reader, a laser reader, or a PDA. The extracting device may be capable of tag extraction, user interface capture, image capture, sound capture, RFID capture, NFC capture or association of these physical representations with a unique meta-element.

The extracting device may be a camera or a smart-phone equipped with a camera. The extracting device may be a smart phone equipped with an RFID or NFC reader. The extracting device may be a browser plugging that extracts HTML codes from a web page. The extracting device may be an email package operating on a computer, smart phone or tablet, wherein the email package is capable of forwarding an email, a text message or an MMS message to a specific location or address.

The computer-implemented method may include transmitting a unique transaction identifier from the extracting device to the submission system.

The computer-implemented method may include transmitting one or more submission data records based on said unique transaction identifier from the submission system to one or more remote computers. The one or more submission data records may be related to a single transaction or multiple transactions.

The computer implemented method may include transmitting one or more submission data records based on said unique transaction identifier from a remote computer to another remote computer.

The computer-implemented method may include transmitting one or more submission data records based on said unique transaction identifier from a remote computer to another remote computer.

Embodiments may include a transaction processing system. The transaction processing system may include an Ad-hoc Pair of Computers (APC). The APC may include a first computer capable of performing a first method and a second computer capable of performing a second method. The first method may include the steps of accessing a transactional collection of records of goods or services, accessing one or more property attributes associated with one or more goods or services of said transactional collection, accessing at least one attributable submission indicator, generating one or more submission data records from said one or more property attributes and said at least one attributable submission indicator, generating a meta-element associated with said submission data records, and generating one or more representations of said meta-element. The property attribute may include a chemical property, a physical property, a nutritional property, an economic property, a mechanical property, a geographic property, a manufacturing property, or a temporal property. The at least one attributable submission indicator may include location, time or consumer ID.

The second method may include extracting the one or more representations of said meta-element with an extracting device, accessing one or more extraction attributes, extracting the one or more extraction attributes, and transmitting said one or more extraction attributes to the first computer. The one or more extraction attributes may include location, time or space.

The first computer or the second computer may be capable of performing the method including generating a unique transaction identifier based on said meta-element and said one or more extraction attributes, and transmitting said unique transaction identifier to the other computer of the APC.

The one or more representations of said meta-element may be physical, digital, or logical.

The transaction processing system may include a third computer connected to the first computer and the second computer using one or more communications networks. The third computer may be capable of maintaining a personalized database of information associated with the second computer.

Upon transmission of the unique transaction identifier between computers in the APC, the first computer or the second computer may transmit said unique transaction identifier to the third computer. The first computer may transmit a message including one or more of said property attributes associated with one or more goods or services of said transactional collection to the third computer for inclusion in said personalized database.

The transaction processing system may include a third computer connected to the first computer and the second computer using one or more communications networks. The third computer may be capable of maintaining a personalized database of information associated with the second computer. Upon transmission of the transaction identifier between computers in the APC, the first computer or the second computer may transmit said unique transaction identifier to the third computer. The third computer may transmit a message including one or more of said property attributes associated with one or more goods or services of said transactional collection to the first computer.

The transaction processing system may include a fourth computer connected to the first computer using one or more communications networks. The fourth computer may be capable of maintaining a database of information about goods or services. The database of information about goods or services may maintain one or more property attributes associated with one or more goods or services. A property attribute may include a chemical property, a physical property, a nutritional property, an economic property, a mechanical property, a geographic property, or a temporal property. The first computer may be capable of querying the fourth computer for one or more property attributes of goods or services from said database to transactional collection.

The first computer may be capable of performing the steps of accessing one or more lists of goods or services, accessing one or more property attributes associated with one or more goods or services of said lists for each list, and transmitting messages including one or more of said property attributes associated with one or more goods or services of said lists to the third computer for inclusion in said personalized database of information associated with the second computer. The property attribute may include a chemical property, a physical property, a nutritional property, an economic property, or a temporal property.

The first computer may be capable of performing the steps of accessing one or more lists of goods or services, accessing one or more property attributes associated with one or more goods or services of said lists, and transmitting information including the one or more property attributes associated with the one or more goods or services of said lists to the third computer. The property attribute may include a chemical property, a physical property, a nutritional property, an economic property, or a temporal property.

The transaction processing system may include a third computer capable of transmitting information including the one or more property attributes associated with the first computer. The one or more property attributes may include a physical property, a nutritional property, an allergy property, an inventory property; and a preference property.

The third computer may be capable of performing the step of transmitting information including one or more of said property attributes associated with one or more goods or services of said new lists to the fourth computer. The one or more property attributes may include a physical property, a nutritional property, an allergy property, an inventory property; and a preference property.

The fourth computer may be capable of performing the steps of accessing one or more list of goods or services, accessing one or more property attribute associated with one or more goods or services of said lists, and transmitting information including one or more of said property attributes associated with one or more goods or services of said lists to the third computer for inclusion in said database. The property attribute may include a chemical property, a physical property, a nutritional property, an economic property, or a temporal property.

The third computer may be capable of performing the step of receiving information including one or more of property attributes associated with one or more goods or services from the fourth computer.

In an embodiment, a retail store may generate a receipt at its point of sale. Unlike current receipts, a specific code (graphic, numeric, alphanumeric or combination) may be added to the receipt. This system may be referred to as a submission system (as in other embodiments it can take on form factors). A consumer may scan the receipt using his or her cellphone to cause the transfer of the information on the receipt (and optionally additional ancillary information) from the retailer computer system to a database or storage location (for example, a location on the world wide web) dubbed a kitchen diary or kitchen dashboard on behalf of the consumer. This location may be provided to the retailer database manager integrating information about the scanned receipt, information such as device and application ID, of the scanning device making the scan and generating a request to the kitchen diary, which in turn makes a request to the retailer computer system for transfer.

In another embodiment, the scanning device may be a smartphone and the kitchen diary may be accessible directly on that cell phone. In such a case, the receipt may be transmitted directly onto the phone for processing by the kitchen diary app (application).

In another embodiment, a local wireless connection may be used to display the receipt on the cell phone directly. The local wireless connection may include but is not limited to RFID, NFC or tap and go.

In another embodiment, a wide-area wireless connection may be used to transfer a representation of the receipt on the cell phone directly. A wide-area wireless connection may include but is not limited to 2G, 3G, 4G-LTE cellular system, WiMAX system or WIFI.802.1x system.

In an embodiment, this transfer of information may be implemented using the Association for Retail Technology Standards XML digital receipt standard augmented by specific fields.

In an embodiment, the scanning device may transmit ancillary information about the scanning process to the kitchen diary to provide context to the purchase to the scanning and enhance kitchen diary operation. This information may include but is not limited to time of scanning, location of scanning, the person scanning, method of scanning (application parameters) and loyalty and credit data stored on the mobile phone. It is important to note that the time of scanning is not necessarily done at shopping as the consumer might wait to be home to authorize the transfer of information from the retailer to the kitchen diary. When the scanning takes place and where the scanning takes place may be an important piece of information related to a specific store that is used in embodiments herein.

In an embodiment, additional information may be transmitted from the retailer computer or from computers of a company that has a relationship with the retailer to enhance the transfer of information about the purchase. To cater to different consumer needs, this information may include but is not limited to:
a. a chemical property indicating, for instance, the presence of preservatives or MSG,
b. a physical property indicating, for instance but not limited to, temperature for storage (e.g. frozen, refrigerated, room temperature), distinct colors or marking of packaging,
c. a nutritional property indicating, for instance but not limited to, calories or ingredients,
d. an economic property indicating, for instance but not limited to, cost, discount and potential future offers,
e. a mechanical property indicating, for instance but not limited to shape of package or prepared food—say chopped lettuce or sliced potatoes—
f. a geographic property indicating, for instance but not limited to, location of production being a country or state or county,
g. a manufacturing property indicating, for instance but not limited to, kosher halal, certification with respect to cross-contamination,
h. a temporal property indicating, for instance but not limited to, manufacturing date, use by date, freshness date.

These transfers of information may be done in many separate transmissions subsequent to the original transfers. They may be controlled by the consumer preferences encoding in his or her kitchen diary. These preferences can be organized to include a physical property, a nutritional property, an allergy property, an inventory property, or a preference property, among others.

In another embodiment, tokens or requests are passed from the kitchen diary database to a third party database managed by a food producer such as a consumer packaged good company or a third party service/information company to provide value added services.

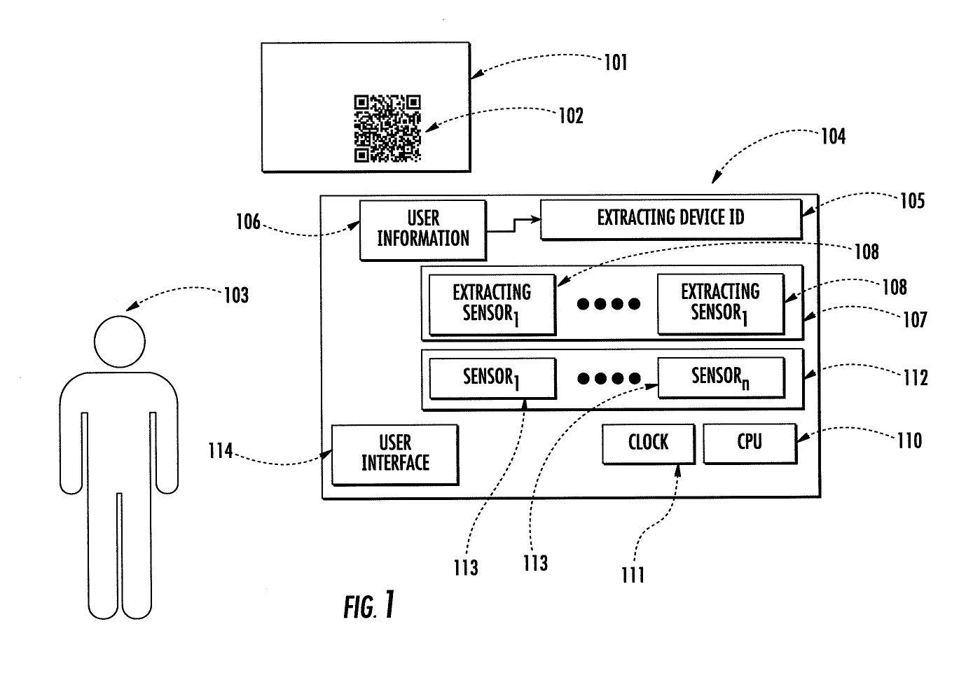

Referring to FIG. 1, generation of context information around a transaction is illustrated. A transaction record (101) is generated by a retailer (not shown) using a point of sale system printer, coupon machine or equivalent. This transaction record may be printed, displayed on screen, recorded on an erasable magnetic strip or stored in non-volatile memory in a device. The transaction record may be transmitted as light, an infrared signal, an electromagnetic signal or a sound wave. A meta-element (102) is included in this transaction record. In an embodiment, the meta-element may be a GSI or QR code printed on a label. In another embodiment, it may also be a pattern of punched out elements on an enclosure. In another embodiment, the meta-element may be a formatted set of bits in a dedicated memory location. In yet another embodiment, the meta-element may be a watermark in an image. In yet another embodiment, the meta-element may be a watermark inside a sound wave. A consumer (103) uses an extracting device (104). The preferred extracting device is a cellular phone or other Receive Transmit Wireless Unit (WRTU). Other potential embodiments include RF powered devices such as key chains or FOBs. Yet, other embodiments include Near-Field Communication (NFC) readers. This extracting device has at least one device ID (105) that is unique to him. This device ID may be derived from a hardware component inside the extracting device such as IMEI (International Mobile Equipment Identity), Media Access Control (MAC) Address, Integrated Circuit Card Identifier (ICCID) of a Subscriber Identification Module (SIM). The device ID may also be derived from user information (106) such as email address, account login information, or name. An extraction sensor bank (107) holds one or more extracting sensors (108), (109) each adapted to a specific type of meta-element (102). The extracting device is controlled by a CPU (110), typically a micro controller such Texas Instrument MSP430 or Apple A5 with volatile and nonvolatile memory. A clock or clock subsystem (111) maintains time and date. A bank (112) of sensors/sensor subsystems (113) is used to capture different attributes. In an embodiment, one of the sensors is an assisted-GPS to capture location information. In another embodiment, one of the sensors extracts the SSID of a Wi-Fi Wireless LAN system comparing it to locally stored set of known SSIDs. In another embodiment, temperature is being measured. In yet another embodiment, a single pixel sensor, such as but not limited to Charge-Coupled Device (CCD) or Complementary Metal-Oxide-Semiconductor (CMOS) sensor is used to measure light. A user interface (114) is used to interface with the user. In an embodiment, the user interface may be among others visual, audio or textual.

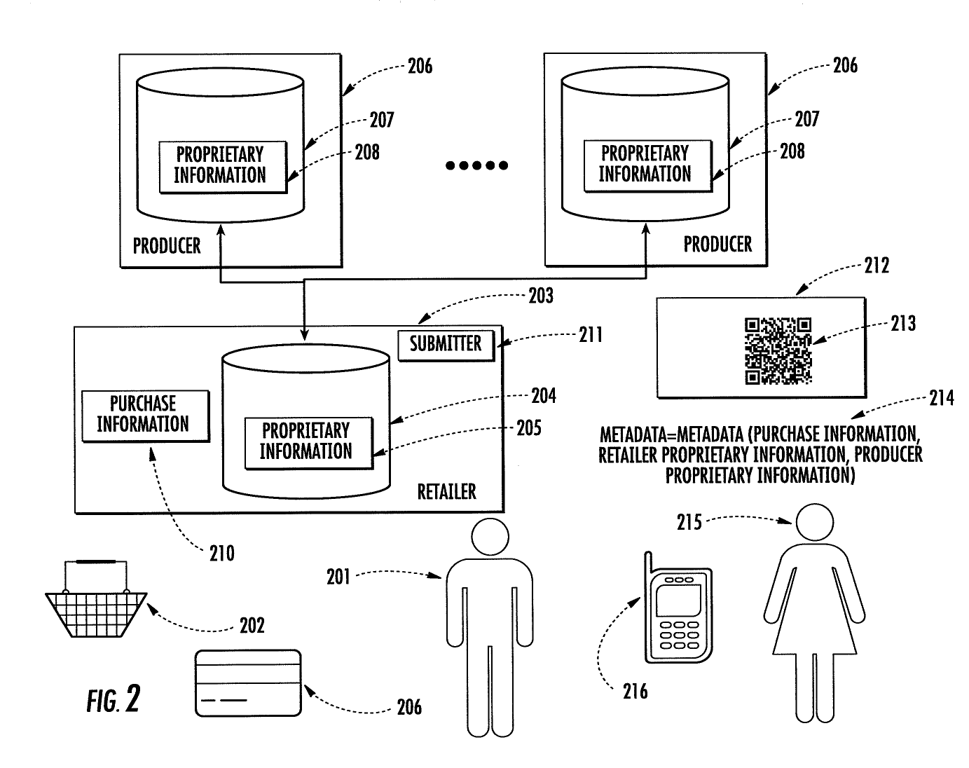

Referring to FIG. 2, the capture of contextual information during a commercial transaction is illustrated. A shopper (201) purchases a set of goods and services (202) at a retailer (203). Typical retailers may include but are not limited to restaurants, grocery stores, supermarkets and online suppliers. The retailer manages a database (204) where information about transactions, inventory, pricing, shelf life and other elements of business are captured and analyzed. Part of the information stored on the database is proprietary information (205) whose access is controlled for safety or privacy reasons. Typical examples of such information may include purchase history (included but not limited to purchase times and locations), store location, or distributor. In this embodiment, the retailer might have a relationship with one or more producers (206). Typical producers may include Consumer Product Groups (CPG), wholesalers or distributors. These producers may also maintain databases (207) in which proprietary information (208) is managed. Typical examples of such information may be nutritional value, expiration date, marketing incentive or origin. Transaction information (210) based on the items purchased (202) is created by the retailer by a transaction submitter (211), typically a Point of Sales (POS) terminal or cash register. A record (212) is generated by the retailer's transaction submitter. A record may include but is not limited to an itemized receipt, credit card receipt, an NFC object or a label affixed to some of the goods purchases. This record includes a metadata (213) whose value is a function (214) of part or whole of purchase information (210), part or whole of retailer proprietary information (205) or producer proprietary information (208). At or around the time of purchase or after the purchase, the shopper or person associated (215) with the shopper uses an extractor to process the metadata (216).

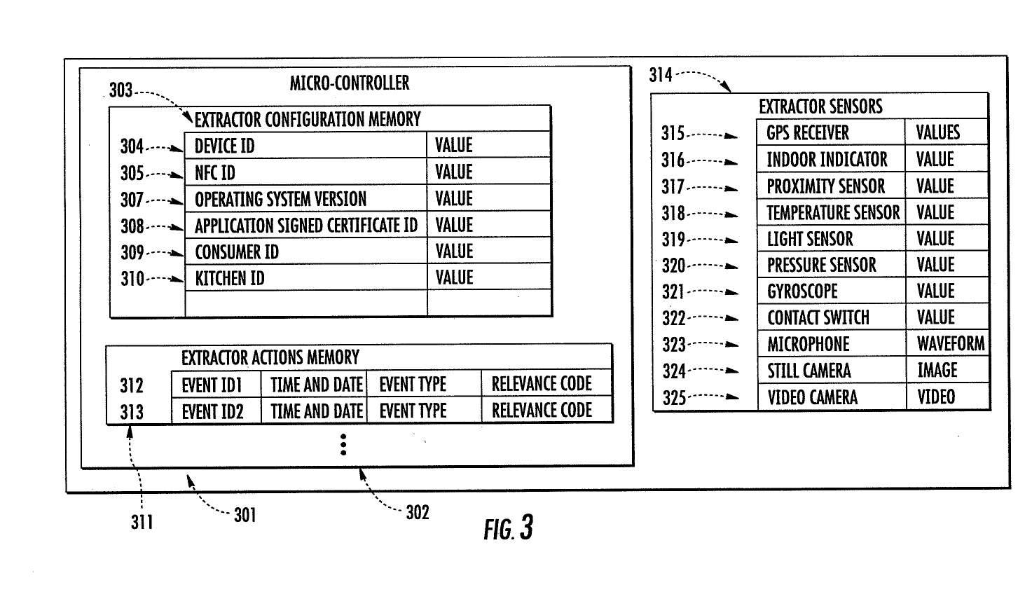

Referring to FIG. 3, a method for context management for electronic device and register/sensor information that may be provided for performance of the method is illustrated. The method and register/memory information illustrated in FIG. 3A-3B are designed for an extractor that is portable. Referring to FIG. 3A, the portable extractor architected to provide context to the extraction of transaction metadata (301) is controlled by a micro-controller (302). This microcontroller includes memory, herein referred to as Extractor Configuration Memory or ECM (303), typically non-volatile (EEPROM or FLASH memory) to store configuration operation about the extractor hardware and software it hosts. This ECM may include but is not limited to: Device ID (304), typically set at manufacturing and unique to each extractor, NFC ID (305) if used also as an electronic wallet, Operating system Version Number (307), Application Signed Certification ID (308) used to register application with the operating system provider, Consumer ID (309) used to identify primary user of extracting device, Kitchen ID (310) an identifier of the primary kitchen group the consumer uses. The microcontroller may also include (or have access to) a memory bank that stores recent transactions dubbed the Extractor Actions Memory or EAM (315). This can be a dedicated memory area or shared with other applications. An event with EventID1 (312) and another one with EventID2 (313) are stored. Each event has among other attributes the time and date recorded, event type (capturing information such as whether the information/exchange associated with the event was pulled, pushed, one-on-one, broadcast, private, public user-initiated, etc.) and Relevance Code used to categorize and organize which past actions are relevant to consider as part of a specific transaction or set of transactions. The extractor has also a bank (314) of sensors used to capture different attributes. A GPS Receiver (315) is used to capture location and speed. An indoor locator (316) is used to detect whether the extractor is indoor or outdoor. This can be accomplished by looking at RF channel response or light spectrum. A proximity sensor (317) (capacitive, inductive or otherwise) is used to check whether the user or an object is near the extractor. A temperature sensor (318) measures temperature (many micro-controllers have a built in temperature sensor). A light sensor (319) measures lighting intensity. A pressure sensor (320) measures pressure. A gyroscope (321) measures the three-dimensional position of the extractor. A contact switch (322) measures whether the extractor is in contact with a solid or liquid surface. A microphone (323) captures sounds. A still camera (324) captures images. A video camera (325) captures videos. The sensors (315) to (324) can store information collected.

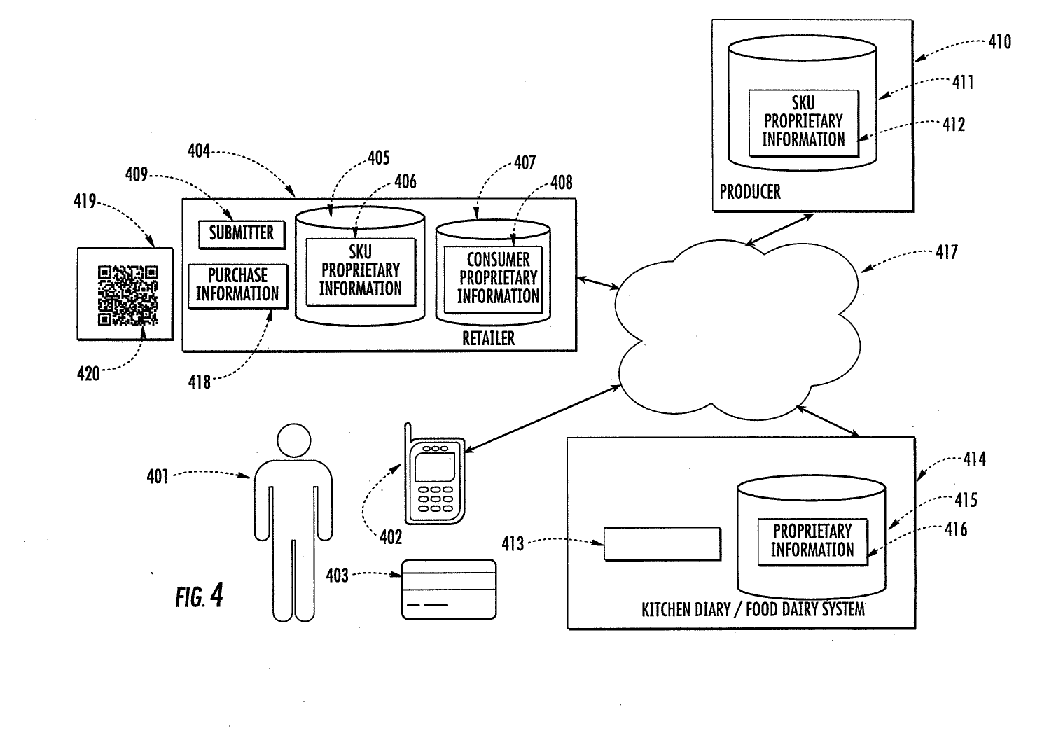

Referring to FIG. 4, the controlled transfer of proprietary information through the use of contextual scanning is illustrated. A shopper (401) carries portable computer/phone (402) along with a loyalty card (203). The shopper transacts within a retailer (404). Typical retailers are restaurants, grocery stores, supermarkets and online suppliers. The retailer manages a database (405) where proprietary information (406) about transactions, inventory, pricing, SKUs, pricing is stored. The retailer also manages a consumer loyalty database (407) where consumer proprietary information (408) is kept. The consumer identity is typically encoded in a loyalty card such as (403). Typical example of such information is purchase history (including but not limited to purchase times and locations), store location, distributor. The retailer has a Point of Sale System (POS) (409) which acts as an information submitter. This POS can be fixed, self-checkout or mobile. The retailer is connected to producer (410). Typical producers may include Consumer Product Groups, farmers, wholesalers or distributors. This producer may maintain a database (411) in which proprietary information (412) is managed. Typical examples of such information may be nutritional value, ingredients. Marketing incentive or origin. Shopper has an account (413) to a food/kitchen management service, dubbed kitchen diary or food diary. This service is typically hosted on a cloud-based service/system (414). This system maintains a database (415) where information about the user is maintained (416). Typical information would be status of items in pantry, food allergy, preferences, and home calendar. Producer, Retailer, and food/system systems are connected using the Internet (417). At the end of a purchase, purchase information (418) is used by submitter to create a receipt (419), which has an identifiable and unique mark (420). Using the handheld computer, the consumer scans the receipt. Information about the purchase is then transmitted from retailer and producer to the kitchen/food diary system.

The references cited throughout this application, are incorporated for all purposes apparent herein and in the references themselves as if each reference was fully set forth. For the sake of presentation, specific ones of these references are cited at particular locations herein. A citation of a reference at a particular location indicates a manner in which the teachings of the reference are incorporated. However, a citation of a reference at a particular location does not limit the manner in which all of the teachings of the cited reference are incorporated for all purposes.

### Embodiment List

The following list includes particular embodiments. The list, however, is not limiting and does not exclude alternate embodiments otherwise described or as would be appreciated by one of ordinary skill in the art.

1. A computer-implemented method for recording transactions for goods or services, and their associated context, between one or more suppliers, and one or more consumers comprising:

accessing a list of goods or services using a submission system;

accessing one or more property attributes associated with one or more goods or services of said list of goods or services,;

accessing at least one attributable submission indicator;

generating one or more submission data records from said one or more property attributes, and said at least one attributable submission indicator within a submission system;

generating one or more meta-elements associated with said one or more submission data records;

generating one or more representations of said one or more meta-elements;

extracting said one or more meta-elements from a physical, logical or digital representation with an extracting device;

accessing one or more extraction attributes; and

generating at least one unique transaction identifier based on said one or more meta-elements and said one or more extraction attributes.

2. The computer-implemented method of embodiment 1, wherein the one or more property attributes are selected from the group consisting of: a chemical property; a physical property; a nutritional property; an economic property; a mechanical property; a geographic property; a manufacturing property; and a temporal property.

3. The computer-implemented method of any one or more of embodiments 1-2, wherein the at least one attributable submission indicator is selected from the group consisting of location; time; and consumer ID.

4. The computer-implemented method of any one or more of embodiments 1-3, wherein the one or more extraction attributes are selected from the group consisting of location; speed; time; velocity; orientation; sound; lighting; extracting device parameters; and application parameters.

5. The computer-implemented method of any one or more of embodiments 1-4, wherein representation of said one or more meta-elements is physical, digital, or logical.

6. The computer-implemented method of any one or more of embodiments 1-5, wherein the one or more representations of said one or more meta-elements are selected from the group consisting of: a graphic icon; a numeric sequence; an alphanumeric sequence; a display; a barcode; a QR code; a watermark; a tattoo; an RFID; an NFC tag; a captured image; chemical and nano-particulate taggants; a mechanical deformation; a mechanical alternation; an e-mail; an attachment to an email; a button on a touch-screen; and an element of interface.

7. The computer-implemented method of any one or more of embodiments 1-6, wherein the submission system is selected from the group consisting of: a personal computer; a computer; a point of sell system; a portable point of sale system; a cellphone; a tablet; a cash register; a server; a cloud based system; an electronic transaction device; a transaction log processing system; a restaurant management system; a kitchen management system; a webpage presented on browser; and an inventory management system.

8. The computer-implemented method of any one or more of embodiments 1-7, wherein the extracting device is selected from the group consisting of: a personal computer; a wireless transmit/receive unit; a cellphone; a tablet; an FOB; a scanner; a near-field communication reader; an infrared reader; an LED reader; a laser reader; and a PDA.

9. The computer-implemented method of any one or more of embodiments 1-8, wherein the extracting device is capable of one or more of the following: tag extraction, user interface capture, image capture, sound capture, RFID capture, NFC capture and association of these physical representations with a unique meta-element.

10. The computer-implemented method of any one or more of embodiments 1-9, wherein the extracting device is a camera or a smart-phone equipped with a camera.

11. The computer implemented method of any one or more of embodiments 1-9, wherein the extracting device is a smart phone equipped with an RFID or NFC reader.

12. The computer-implemented method of any one or more of embodiments 1-9, wherein the extracting device is a browser pluggin that extracts HTML codes from a web page.

13. The computer-implemented method of any one or more of embodiments 1-9, wherein the extracting device is an email package operating on a computer, smart phone or tablet, wherein the email package is capable of forwarding an email, a text message or an MMS message to a specific location or address.

14. The computer-implemented method of any one or more of embodiments 1-13 further comprising transmitting a unique transaction identifier from the extracting device to the submission system.

15. The computer-implemented method of embodiment 14 further comprising transmitting one or more submission data records based on said unique transaction identifier from the submission system to one or more remote computers.

16. The computer-implemented method of embodiment 14 further comprising transmitting one or more submission data records based on said unique transaction identifier from a remote computer to another remote computer.

17. The computer-implemented method of any one or more of embodiments 15-16, wherein the one or more submission data records are related to a single transaction.

18, The computer-implemented method of any one or more of embodiments 15-16, wherein the one or more submission data records are related to multiple transactions.

19. A transaction processing system comprising:

an Ad-hoc Pair of Computers (APC), wherein the APC includes:

a first computer capable of performing a first method; and

a second computer capable of performing a second method,

wherein the first method comprises:

accessing a transactional collection of records of goods or services;

accessing one or more property attributes associated with one or more goods or services of said transactional collection;

accessing at least one attributable submission indicator;

generating one or more submission data records from said one or more property attributes and said at least one attributable submission indicator;

generating a meta-element associated with said submission data records; and

generating one or more representations of said meta-element,

wherein the second method comprises:

extracting the one or more representations of said meta-element with an extracting device;

accessing one or more extraction attributes;

extracting the one or more extraction attributes; and

transmitting said one or more extraction attributes to the first computer,

wherein the first computer or the second computer is capable of performing the method:

generating a unique transaction identifier based on said meta-element and said one or more extraction attributes; and

transmitting said unique transaction identifier to the other computer of the APC.

20. The transaction processing system of embodiment 19, wherein the one or more property attributes are selected from the group consisting of a chemical property; a physical property; a nutritional property; an economic property; a mechanical property; a geographic property; a manufacturing property; and a temporal property.

21. The transaction processing system of any one or more of embodiments 19-20, wherein the at least one attributable submission indicator is selected from the group consisting of location; time; and consumer ID.

22. The transaction processing system of any one or more of embodiments 19-21, wherein the one or more extraction attributes is selected from the group consisting of location; time; and space.

23. The transaction processing system of any one or more of embodiments 19-22, wherein the one or more representations of said meta-element are physical, digital, or logical.

24. The transaction processing system of any one or more of embodiments 19-23 further comprising:
a third computer connected to the first computer and the second computer using one or more communications networks,
wherein the third computer is capable of maintaining a personalized database of information associated with the second computer,

wherein upon transmission of the unique transaction identifier between computers in the APC, the first computer or the second computer transmits said unique transaction identifier to the third computer, and

wherein the first computer transmits a message including one or more of said property attributes associated with one or more goods or services of said transactional collection to third computer for inclusion in said personalized database.

25. The transaction processing system of any one or more of embodiments 19-24 further comprising:

a third computer connected to the first computer and the second computer using one or more communications networks,

wherein the third computer is capable of maintaining a personalized database of information associated with the second computer,

wherein upon transmission of transaction identifier between computers in the APC, the first computer or the second computer transmits said unique transaction identifier to the third computer, and

wherein the third computer transmits a message including one or more of said property attributes associated with one or more goods or services of said transactional collection to the first computer.

26. The transaction processing system of any one or more of embodiments 19-25 further comprising:

a fourth computer connected to the first computer using one or more communications networks,

wherein the fourth computer is capable of maintaining a database of information about goods or services,

wherein the database of information about goods or services maintains one or more property attributes associated with one or more goods or services, wherein a property attribute is selected from the group consisting of: a chemical property; a physical property; a nutritional property; an economic property; a mechanical property; a geographic property; and a temporal property, and

wherein the first computer is capable of querying the fourth computer for one or more property attributes of goods or services from said database to transactional collection.

27. The transaction processing system of embodiment 24, wherein the first computer is capable of performing the steps of:

accessing one or more lists of goods or services;

accessing one or more property attributes associated with one or more goods or services of said lists for each list, wherein the property attribute is selected from the group consisting of: a chemical property; a physical property; a nutritional property; an economic property; and a temporal property; and

transmitting messages including one or more of said property attributes associated with one or more goods or services of said lists to the third computer for inclusion in said personalized database of information associated with the second computer.

28. The transaction processing system of embodiment 24, wherein the first computer is capable of performing the steps of:

accessing one or more lists of goods or services;

accessing one or more property attributes associated with one or more goods or services of said lists; and

transmitting information including the one or more property attributes associated with the one or more goods or services of said lists to the third computer.

29. The transaction processing system of embodiment 28, wherein the one or more property attributes are selected from the group consisting of a chemical property; a physical property; a nutritional property; an economic property; a mechanical property; a geographic property; and a temporal property.

30. The transaction processing system of any one or more of embodiments 13-29 further comprising a third computer capable of transmitting or receiving information including the one or more property attributes associated with the first computer.

31. The transaction processing system of embodiment 30, wherein the one or more property attributes are selected from the group consisting of a physical property; a nutritional property; an allergy property; an inventory property; and a preference property.

32. The transaction processing system of embodiment 30, wherein the third computer is capable of performing the step of transmitting information including one or more of said property attributes associated with one or more goods or services of said new lists to the fourth computer, wherein the one or more of said property attributes is an attribute is selected from the group consisting of: a physical property; a nutritional property; an allergy property; a inventory property; and a preference property.

33. The transaction processing system of embodiment 20, wherein the fourth computer is capable of performing the steps of:

accessing one or more list of goods or services;

accessing one or more property attributes associated with one or more goods or services of said lists, wherein the property attribute is selected from the group consisting of: a chemical property; a physical property; a nutritional property; an economic property; and a temporal property; and

transmitting information including one or more of said property attributes associated with one or more goods or services of said lists to the third computer for inclusion in said database.

34. The transaction processing system of embodiment 30 wherein the third computer is capable of performing the step of receiving information including one or more of property attributes associated with one or more goods or services from the fourth computer.

The methods herein may be implemented on myriad types of devices and/or combinations of devices. Combinations of devices may be functionally connected by physical or wireless connections as known in the art. A device may include a processor, a memory device, a communication interface, a data storage device, and a display, which may be a touchscreen display. These components may be connected via a system bus in the device, and/or via other appropriate interfaces within the device.

The memory device may be or include a device such as a Dynamic Random Access Memory (D-RAM), Static RAM (S-RAM), or other RAM or a flash memory.

The data storage device may be or include a hard disk, a magneto-optical medium, an optical medium such as a CD-ROM, a digital versatile disk (DVDs), or Blu-Ray disc (BD), or other type of device for electronic data storage. The data storage device may store instructions that define the application, and/or data that is used by the application.

The communication interface may be, for example, a communications port, a wired transceiver, a wireless transceiver, and/or a network card. The communication interface may be capable of communicating using technologies such as Ethernet, fiber optics, microwave, xDSL (Digital Subscriber Line), Wireless Local Area Network (WLAN) technology, wireless cellular technology, and/or any other appropriate technology.

The touchscreen display may be based on one or more technologies such as resistive touschreen technology, surface acoustic wave technology, surface capacitive technology, projected capacitive technology, and/or any other appropriate touchscreen technology. When the touchscreen receives data that indicates user (e.g., a consumer, prospective consumer, or registered consumer) input, the touchscreen may provide data to an application implementing at least a portion of a method herein.

A method or at least a portion of a method herein may be described as being performed by an application. It should be understood, however, that these actions are actually performed by the processor (in conjunction with a persistent storage device, network interface, memory, and/or peripheral device interface) in the device, according to instructions defined in the application. The instructions may be stored on a computer readable medium. Alternatively or additionally, the memory device and/or the data storage device in the device may store instructions which, when executed by the processor, cause the processor to perform any feature or any combination of features described above as performed by the application. Alternatively or additionally, the memory device and/or the data storage device in the device may store instructions which, when executed by the processor, cause the processor to perform (in conjunction with the memory device, communication interface, data storage device, and/or the display, which may be a touchscreen display) any feature or any combination of features described above as performed by the application.

As used herein, the term “processor” broadly refers to and is not limited to a single- or multi-core central processing unit (CPU), a special purpose processor, a conventional processor, a Graphics Processing Unit (GPU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine.

As used herein, the term “computer-readable medium” broadly refers to and is not limited to a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVDs, or BD, or other type of device for electronic data storage.

The features described herein may also be implemented, mutatis mutandis, on a desktop computer, a laptop computer, a netbook, a cellular phone, a personal digital assistant (PDA), or any other appropriate type of computing device or data processing device.

Although features and elements are described above in particular combinations, each feature or element can be used alone or in any combination with or without the other features and elements. For example, each feature or element as described above may be used alone without the other features and elements or in various combinations with or without other features and elements. Sub-elements of the methods and features described above may be performed in any arbitrary order (including concurrently), in any combination or sub-combination.

Further embodiments herein may be formed by supplementing an embodiment with one or more element from any one or more other embodiment herein, and/or substituting one or more element from one embodiment with one or more element from one or more other embodiment herein.

### EXAMPLES

The following non-limiting examples are provided to illustrate particular embodiments. The embodiments throughout may be supplemented with one or more detail from one or more example below, and/or one or more element from an embodiment may be substituted with one or more detail from one or more example below.

An example of embodiment 11 is the case when the consumer allows through one interaction for emails from the retailers to be directed or redirected to a specific address from that point forward.

An example of the transfer of data records of embodiment 12 is the case where the consumer computer or a cloud server acting on behalf of the computer queries the retailer computer (or server) and pulls information from said computer/server.

Another example of this embodiment is the case where the consumer computer or a cloud server acting on behalf of the computer queries the goods manufacturer or service provider computer (or server) and pulls information from said computer/server.

An example of the transfer of data records of embodiment 12 is the case the retailer computer (or server) and pushes information from said computer/server to the consumer PC or cloud server.

An example of the transfer of data records of embodiment 12 is the case the good manufacturer or service provider computer (or server) and pushes information from said computer/server to the consumer PC or cloud server.

An example of economic property in embodiment 14 is an identifier of the brand associated with the product, another one is the method/carrier/network used to transport goods. Another example is an identifier of the store location, store name, or chain. An example of manufacturing property is the ID of the manufacturing plant, country for part of the goods or services.

An example of embodiment 24 is the case where the third computer is the consumer computer that pulls transaction information from a secure website managed by the retailers.

An example of embodiment 24 is the case where the third computer is a cloud server that pulls transaction information from a secure website managed by the retailers.

It is understood, therefore, that this invention is not limited to the particular embodiments disclosed, but is intended to cover all modifications which are within the spirit and scope of the invention as defined by the appended claims; the above description; and/or shown in the attached drawings.

What is claimed is:

1. A method of generating contextual information associated with a commercial transaction, the method comprising:
receiving a unique transaction identifier from a scanned code, wherein the unique transaction identifier identifies a specific commercial transaction between a consumer and a retailer and serves as an authorization, by the consumer, to transfer information relating to the specific commercial transaction to a database associated with an account of the consumer;
on a condition that the unique transaction identifier is received from the scanned code:
retrieving, from a computer associated with the retailer, at least a list of goods purchased by the consumer during the transaction,
determining additional information to retrieve based on at least one preference of the consumer, wherein the additional information includes at least one of:
nutritional information for goods purchased by the consumer,
a list of ingredients included in the goods purchased by the consumer,
information regarding manufacturing of the goods purchased by the consumer,
information regarding timing of expiration of the goods purchased by the consumer,
information regarding pricing of the goods purchased by the consumer, or
information regarding how to store the goods purchased by the consumer,
retrieving the additional information, and
storing the retrieved information in the database associated with the account of the consumer for use in providing at least one of food budgeting services, diet monitoring services or economic offers to the consumer through an application.

2. The method of claim 1, wherein the scanned code is one of a GS1 code or a quick response (QR) code printed on a receipt generated for the specific commercial transaction.

3. The method of claim 1, wherein the retrieving the list of goods purchased and the additional information include querying at least the computer associated with the retailer and pulling the list of goods purchased and the additional information from the queried computer.

4. The method of claim 1, wherein the retrieving the list of goods purchased by the consumer and the additional information include receiving the list and the additional information that is pushed from at least the computer associated with the retailer.

5. The method of claim 1, wherein the determining the additional information to retrieve includes retrieving and decoding the at least one preference of the consumer.

6. The method of claim 1, further comprising:
generating information regarding the scanning of the scanned code using a code reader, the information regarding the scanning of the scanned code including at least one of a time of the scanning, a date of the scanning, a location of the scanning, an identity of the consumer that performed the scanning, or a method used for the scanning; and
storing the generated information regarding the scanning of the scanned code in the database associated with the account of the consumer.

7. The method of claim 1, wherein the additional information further includes information stored on a wireless receive/transmit unit (WRTU) of the consumer.

8. The method of claim 1, wherein the retrieving the additional information further includes retrieving the additional information from at least one of a computer associated with the manufacturer of the goods purchased by the consumer, a computer associated with a consumer product group, a computer associated with a wholesaler, or a computer associated with a distributer.

9. The method of claim 1, wherein the account of the consumer is associated with a service hosted on a cloud-based server.

10. A wireless receive/transmit unit (WRTU) comprising:
an antenna;
a code reader; and
at least one processor configured to:
receive a unique transaction identifier, from the code reader, the unique transaction identifier being extracted from a scanned code, wherein the unique transaction identifier identifies a specific commercial transaction between a consumer and a retailer and serves as an authorization, by the consumer, to transfer information relating to the specific commercial transaction to a database associated with an account of the consumer,
on a condition that the unique transaction identifier is received from the code reader:
retrieve, via the antenna from a computer associated with a retailer, at least a list of goods purchased by the consumer during the transaction,
determine additional information to retrieve based on at least one preference of the consumer, wherein the additional information includes at least one of:
nutritional information for goods purchased by the consumer,
a list of ingredients included in the goods purchased by the consumer,
information regarding manufacturing of the goods purchased by the consumer,
information regarding timing of expiration of the goods purchased by the consumer,
information regarding pricing of the goods purchased by the consumer, or
information regarding how to store the goods purchased by the consumer,
retrieve the additional information, and
store the retrieved information in the database associated with the account of the consumer for use in providing at least one of food budgeting services, diet monitoring services or economic offers to the consumer through an application running on the WRTU.

11. The WRTU of claim 10, wherein the code reader is configured to read one of a GS1 code or a quick response (QR) code printed on a receipt generated for the specific commercial transaction.

12. The WRTU of claim 10, wherein the processor is further configured to retrieve the list of goods purchased and the additional information by querying at least the computer associated with the retailer and pulling the list of goods purchased and the additional information from the queried computer.

13. The WRTU of claim 10, further comprising at least one of:
a global positioning system (GPS) receiver,
an ambient light sensor,
a proximity sensor,
a temperature sensor,
a pressure sensor,
a gyroscope,
a microphone,
a still camera,
a video camera, or
a clock,
wherein the at least one of the GPS receiver, the ambient light sensor, the proximity sensor, the temperature sensor, the pressure sensor, the gyroscope, the microphone, the still camera, the video camera or the clock is configured to generate information regarding the scanning of the scanned code.

14. The WRTU of claim 10, further comprising a memory configured to store at least some of the additional information.

15. A system comprising:
a first computer configured to generate a receipt in connection with a commercial transaction between a consumer and a retailer and affix a scannable code to the receipt;
a database associated with an account of the consumer;
a scanning device configured to scan the scannable code and provide a unique transaction identifier extracted from the scanned code, wherein the unique transaction identifier identifies the commercial transaction between the consumer and the retailer and serves as an authorization, by the consumer, to transfer information relating to the commercial transaction to the database associated with the account of the consumer; and
a second computer configured to:
on a condition that the unique transaction identifier is received from the scanning device:
retrieve, from the first computer, at least a list of goods purchased by the consumer during the commercial transaction,
determine additional information to retrieve based on at least one preference of the consumer, wherein the additional information includes at least one of:
nutritional information for goods purchased by the consumer,
a list of ingredients included in the goods purchased by the consumer,
information regarding manufacturing of the goods purchased by the consumer,
information regarding timing of expiration of the goods purchased by the consumer,
information regarding pricing of the goods purchased by the consumer, or
information regarding how to store the goods purchased by the consumer,
retrieve the additional information, and
store the retrieved information in the database associated with the account of the consumer for use in providing at least one of food budgeting services, diet monitoring services or economic offers to the consumer through an application.

16. The system of claim 15, wherein the scanning device is part of one of the first computer, the second computer or a wireless receive/transmit unit (WRTU).

17. The system of claim 15, wherein the scanned code is one of a GS1 code or a quick response (QR) code printed on the receipt generated in connection with the commercial transaction.

18. The system of claim 15, wherein the second computer is further configured to retrieve the list of goods purchased and the additional information by querying at least the first computer and pulling the list of goods purchased and the additional information from the queried computer.

19. The system of claim 15, wherein the scanning device further comprises at least one of:
a global positioning system (GPS) receiver,
an ambient light sensor,
a proximity sensor,
a temperature sensor,
a pressure sensor,
a gyroscope,
a microphone,
a still camera,
a video camera, or
a clock,
wherein the at least one of the GPS receiver, the ambient light sensor, the proximity sensor, the temperature sensor, the pressure sensor, the gyroscope, the microphone, the still camera, the video camera or the clock is configured to generate information regarding the scanning of the scanned code.

20. The system of claim 15, further comprising a cloud-based server, wherein the account of the consumer is associated with a service hosted on the cloud-based server.
